(19) United States
(12) Patent Application Publication
(10) Pub. No.: US 2025/0220052 A1
(43) Pub. Date: Jul. 3, 2025

(54) DATA PROCESSING METHOD, SYSTEM, DEVICE, AND STORAGE MEDIUM

(71) Applicant: CLOUD INTELLIGENCE ASSETS HOLDING (SINGAPORE) PRIVATE LIMITED, Singapore (SG)

(72) Inventors: Huorong LI, Beijing (CN); Sheng WANG, Singapore (SG); Yiran LI, Beijing (CN); Le SU, Singapore (SG); Yanshan ZHANG, Singapore (SG); Feifei LI, Hangzhou (CN)

(21) Appl. No.: 18/851,021

(22) PCT Filed: Mar. 24, 2023
(86) PCT No.: PCT/CN2023/083586

§ 371 Date: Sep. 25, 2024

(30) Foreign Application Priority Data
Mar. 25, 2022 (CN) 202210300755.8

(51) Int. Cl. H04L 9/40

(52) U.S. Cl. CPC H04L 63/205; H04L 63/101

(57) ABSTRACT

Embodiments of the present application provide a data processing method, system, device and storage medium, where a processing request for target data sent by a requesting party having an access permission is received; a first identifier of a first user to which the target data belongs and a second identifier of the requesting party are obtained; a data processing rule pre-agreed upon by the first user and the requesting party is searched for according to the first identifier and the second identifier; and when a processing operation specified by the processing request complies with the data processing rule, the target data is processed according to the data processing rule to feedback corresponding response information to the requesting party, which can meet processing requirements of the requesting party for the target data, and effectively improve security protection effect during a process in which the target data is secure processing.

### CROSS-REFERENCE TO RELATED APPLICATIONS

The present application is a National Stage of International Application No. PCT/CN2023/083586, filed on Mar. 24, 2023, which claims priority to Chinese Patent Application No. 202210300755.8, filed with China National Intellectual Property Administration on Mar. 25, 2022 and entitled “DATA PROCESSING METHOD, SYSTEM, DEVICE, AND STORAGE MEDIUM”. The two applications are hereby incorporated by reference in their entireties.

### TECHNICAL FIELD

The present application relates to the field of computer technology and, in particular, to a data processing method, a system, a device, and a storage medium.

### BACKGROUND

With the rapid development of cloud computing technology, a problem of data security in a database of a cloud platform is becoming more and more prominent. In order to comprehensively improve effect of security protection, it is necessary to ensure that data in the database is stored, transmitted and used in ciphertext throughout an entire process. This effectively and completely eliminates a possibility of the cloud platform and operations staff having access to plaintext.

However, in practical applications, there are still some cases where private data of a user needs to be disclosed to a third party for a purpose such as a data analysis or for requirements of operation and maintenance of a third-party system. A conventional practice is that terms and conditions are negotiated and signed between the user and the third party for restricting. In order to further enhance the effect of security protection, some users use an Access Control List (ACL) to impose a targeted restriction on user accessibility. Such restriction can only restrict whether the third party can access target data. Once the access is authorized, an operation behavior of the third party performed on the target data is no longer restricted, and it is impossible to know whether the target data of user is processed in a compliant, legal and secure manner. Therefore, a solution is needed to ensure that the data can be processed securely.

### SUMMARY

In order to solve or improve a problem existing in the prior art, embodiments of the present application provide a data processing method, system, device and storage medium.

A first aspect, an embodiment of the present application provides a data processing method, including:
receiving a processing request for target data sent by a requesting party having an access permission;
obtaining a first identifier of a first user to which the target data belongs and a second identifier of the requesting party;
searching for a data processing rule pre-agreed upon by the first user and the requesting party according to the first identifier and the second identifier; and
when a processing operation specified by the processing request complies with the data processing rule, processing the target data according to the data processing rule to feedback corresponding response information to the requesting party.

A second aspect, an embodiment of the present disclosure provides another data processing method, including:
sending a request for an agreement on a data processing rule to a data management system; where the request for the agreement is associated with a restriction for a data processing behavior of a requesting party;
if a first user responds to the request for the agreement and completes a signing on the data processing rule, generating a behavior control list containing the data processing rule, and storing the behavior control list in the data management system; and
performing a data processing operation on target data based on the behavior control list.

A third aspect, an embodiment of the present disclosure provides yet another data processing method, including:
sending a request for an agreement on a data processing rule to a data management system; where the request for the agreement is associated with a restriction for a data processing behavior of a requesting party; and
if the requesting party responds to the request for the agreement and completes a signing on the data processing rule, generating a behavior control list containing the data processing rule to enable the requesting party to initiate a processing request for target data based on the behavior control list.

A fourth aspect, an embodiment of the present disclosure provides a data processing system, including:
a data management system, configured to receive a processing request for target data sent by a requesting party having an access permission; obtain a first identifier of a first user to which the target data belongs and a second identifier of the requesting party; search for a data processing rule pre-agreed upon by the first user and the requesting party according to the first identifier and the second identifier; and in a case that a processing operation specified by the processing request complies with the data processing rule, process the target data according to the data processing rule to feedback corresponding response information to the requesting party;
the requesting party, configured to send a request for an agreement on the data processing rule to the data management system; where the request for the agreement is associated with a restriction for a data processing behavior of the requesting party; in a case that the first user responds to the request for the agreement and completes a signing on the data processing rule, generate a behavior control list containing the data processing rule, and store the behavior control list in the data management system; and perform a data processing operation on the target data based on the behavior control list; and
the first user, configured to send a request for an agreement on the data processing rule to the data management system; where the request for the agreement is associated with the restriction for the data processing behavior of the requesting party; and in a case that the requesting party responds to the request for the agreement and completes a signing on the data processing rule, generate the behavior control list containing the data processing rule to enable the requesting party to initiate the processing request for the target data based on the behavior control list.

A fifth aspect, an embodiment of the present disclosure provides an electronic device, including: a memory and a processor;
where the memory, configured to store a program;
the processor, coupled to the memory and configured to execute the program stored in the memory to implement the data processing method mentioned in the first aspect; or the another data processing method mentioned in the second aspect; or the yet another data processing method mentioned in the third aspect.

A sixth aspect, an embodiment of the present disclosure provides a non-transitory machine-readable storage medium, the non-transitory machine-readable storage medium stores executable codes thereon, when the executable codes are executed by a processor of an electronic device, the processor is caused to implement the data processing method mentioned in the first aspect; or the another data processing method mentioned in the second aspect; or the yet another data processing method mentioned in the third aspect.

In the technical solution provided by the embodiments of the present application, data in a database is regarded as private data of a first user, in some cases, a third party (a requesting party) needs to process target data privatized by the first user. In order to better ensure data security in a process of processing target data in an all-round way; the first user can authorize the requesting party to allow it to targeted process corresponding target data in a trusted execution environment. Specifically, when the requesting party requests data processing, the requesting party will strictly perform a relevant data processing operation according to a data processing behavior authorized for the requesting party in a behavior control list agreed upon between the requesting party and the first user. It can accurately constrain the data processing behavior of the requesting party, meet processing requirements of the requesting party for the target data, and effectively improve security protection effect during a process in which the target data is secure processing.

### BRIEF DESCRIPTION OF DRAWINGS

To describe the technical solutions in embodiments of the present application or existing arts more clearly, the following briefly introduces the accompanying drawings needed for describing the embodiments or the existing arts. Apparently, the accompanying drawings described below are some embodiments of the present application, persons of ordinary skill in the art may still derive other drawings from these accompanying drawings without creative effort.

FIG. 1 is a flowchart of a data processing method provided by an embodiment of the present application.

FIG. 2 is a schematic diagram of a signing process between a requesting party and a first user provided by an embodiment of the present application.

FIG. 3 is a schematic diagram of a key pair table provided by an embodiment of the present application.

FIG. 4 is a schematic diagram of a verifying process of permission of a requesting party provided by an embodiment of the present application.

FIG. 5 is a schematic diagram of a behavior control list provided by an embodiment of the present application.

FIG. 6 is a schematic diagram of a revoking process of permission provided by an embodiment of the present application.

FIG. 7 is a flowchart of another data processing method provided by an embodiment of the present application.

FIG. 8 is a flowchart of yet another data processing method provided by an embodiment of the present application.

FIG. 9 is a structure schematic diagram of a data processing apparatus provided by an embodiment of the present application.

FIG. 10 is a structure schematic diagram of an electronic device provided by an embodiment of the present application.

FIG. 11 is a structure schematic diagram of another data processing apparatus provided by an embodiment of the present application.

FIG. 12 is a structure schematic diagram of another electronic device provided by an embodiment of the present application.

FIG. 13 is a structure schematic diagram of yet another data processing apparatus provided by an embodiment of the present application.

FIG. 14 is a structure schematic diagram of yet another electronic device provided by an embodiment of the present application.

### DESCRIPTION OF EMBODIMENTS

In order to enable those skilled in the art to better understand the solutions of the present application, the technical solutions in the embodiments of the present application will be clearly and completely described below in conjunction with the accompanying drawings in the embodiments of the present application.

Some processes described in the specification, the claims and the above accompanying drawings of the present application include multiple operations that appear in a specific order. These operations may be executed out of the order in which they appear herein or in parallel. The operation serial numbers, such as 101, 102, etc., are only used to distinguish different operations. The serial numbers themselves do not represent any execution order. Additionally, these processes may include more or fewer operations, and the operations may be executed in an order or in parallel. It should be noted that the descriptions such as “first” and “second” in this article are used to distinguish different messages, devices, modules, etc., and do not represent an order of precedence, nor do they limit “first” and “second” to different types. In addition, embodiments described below are only part of embodiments of the present application, rather than all embodiments. Based on the embodiments in the present application, all other embodiments obtained by those skilled in the art without making any creative work shall fall within the scope of protection of the present application.

With the rapid development of a database technology, a user has increasingly high security requirements for a database when using it. For some data with high encryption requirements, a fully encrypted database can be used to achieve comprehensive encryption protection effect for all aspects of data transmission, calculation, and storage. In practice, although more comprehensive security protection can be achieved for data in the database of the user, in some application scenarios (e.g., data analysis or database operation and maintenance), a third party is required to perform a related data processing. When the third party needs to access the data, access permission of an accessing party will be restricted. If a certain accessing party has the access permission, then the accessing party can access the data of the user. During an access process, the accessing party can perform a corresponding processing on the data of the user according to its own needs without being subject to any constraints or restrictions. This leaves the data of the user without any confidentiality protection, and there is a certain data security risk present. Therefore, a technical solution is needed to improve security protection effect of accessing data in a database. In technical solutions of the present application, specific working processes will be described in the following embodiments.

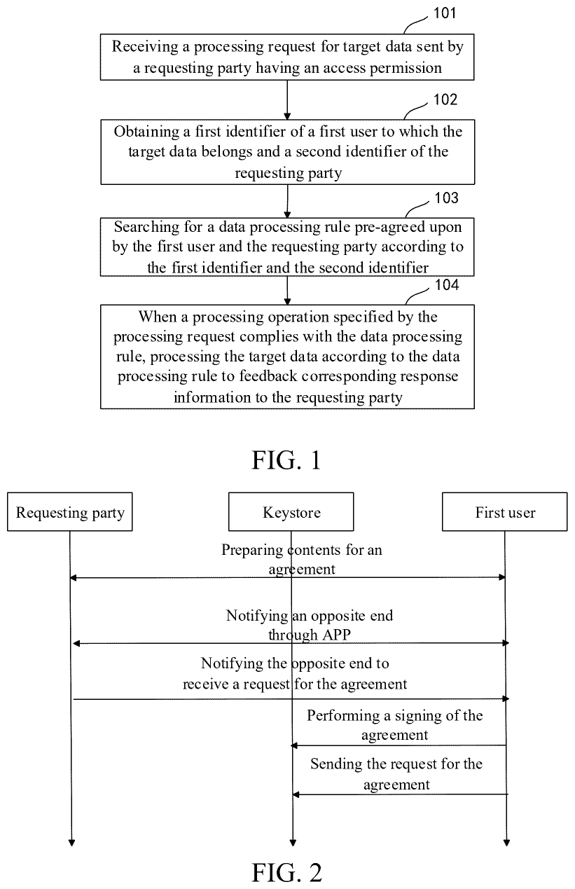

FIG. 1 is a flowchart of a data processing method provided by an embodiment of the present application. An execution entity of the method can be a database (including a local database or a cloud platform database), and the method is executed in a trusted execution environment (TEE). The execution environment usually protects code and data therein from being leaked or maliciously tampered with by providing a secure execution environment isolated from an outside world. The data processing method specifically includes the following steps:
101: receiving a processing request for target data sent by a requesting party having an access permission;
102: obtaining a first identifier of a first user to which the target data belongs and a second identifier of the requesting party;
103: searching for a data processing rule pre-agreed upon by the first user and the requesting party according to the first identifier and the second identifier; and
104: when a processing operation specified by the processing request complies with the data processing rule, processing the target data according to the data processing rule to feedback corresponding response information to the requesting party.

In practical applications, in order to ensure data security in a database, the access permission of the requesting party will be restricted. Specifically, an access request is received from the requesting party; it is determined whether the requesting party has the access permission based on the second identifier carried in the access request; if the requesting party has the access permission, then the processing request for the target data sent by the requesting party is received.

Only a requesting party that has passed an access permission verification is permitted to access a database in which the target data is located. The access permission mentioned here can be verified by a simple whitelist or blacklist manner. If the second identifier of the requesting party is added to the whitelist, the requesting party is permitted to access the database. If the second identifier of the requesting party is added to the blacklist, the requesting party is considered to be an illegal user and poses a threat to data security, when the requesting party initiates an access request, it will not pass the verification, that is, it is not permitted to access the database.

In order to further enhance database security protection effect, a further restriction is imposed on the requesting party having the access permission. Specifically, after the requesting party has passed the access permission verification, the requesting party will send a specific processing request to the database, in the processing request, processing requirements for which target data are clearly specified. Furthermore, the processing request carries the second identifier of the requesting party. The second identifier of the requesting party mentioned here may be an identifier that represents uniqueness of the requesting party, such as a user name or a user ID of the requesting party.

The first identifier of the first user mentioned here can be understood as a unique identifier of a user who owns the target data and has a manage permission to the target data. Any requesting party who wants to access the target data of the first user needs to obtain authorization from the first user. In other words, the access permission mentioned above and the processing request mentioned here are all managed and authorized by the first user.

The data processing rule mentioned here may be a data desensitization processing rule such as data masking (e.g., pseudonym replacement, noise addition, data set replacement) or data blurring (aggregation based on time/data attributes) that is performed on the target data included in the database. It is also possible to be a restriction imposed on an access behavior of the requesting party. For example, the requesting party is restricted to having read-only or write-only permission, etc. In practical applications, the first user can set data processing rules of multiple dimensions for a same requesting party, thereby effectively constraining the data processing behavior of the requesting party and ensuring security of the target data of the first user.

It should be noted that, in the technical solutions of the present application, the data processing rule is pre-agreed upon by the first user and the requesting party. The first user can agree upon a data processing rule with multiple requesting parties at the same time, and a same requesting party can also agree upon a data processing rule with multiple users at the same time. The pre-agreement mentioned here can be understood as that the data processing rule can only take effect on the requesting party after the user and the requesting party perform a signing on a certain data processing rule at the same time. In other words, if a pre-agreement is not completed, the data processing rule will not take effect. It also means that although the requesting party has passed the access permission verification, the requesting party is not permitted to perform any data processing on the target data of the user. The pre-agreement can be initiated by either the user or the requesting party, and it is then generated once both parties have performed the signing.

In practical applications, the data processing rule is stored in a behavior control list. In one or more embodiments of the present application, before r the receiving the processing request for the target data sent by the requesting party having the access permission, the method further includes: receiving a request for an agreement on the data processing rule initiated by the requesting party or the first user; and if the requesting party and the first user complete a signing of the agreement on the data processing rule, generating a behavior control list containing the data processing rule, and storing the behavior control list in a keystore.

FIG. 2 is a schematic diagram of a signing process between a requesting party and a first user provided by an embodiment of the present application. As can be seen from FIG. 2, a first user (an authorizing party, i.e., a first user (Issuer) in FIG. 2) issues a behavior control list (Behavior Control List, BCL) to authorize a requesting party (an authorized party, i.e., a requesting party (Subject) in FIG. 2) to access to target data of the first user based on a data processing rule constrained in a given BCL. In particular, the authorizing party (the first user) and the authorized party (the requesting party) need to perform a signing of an agreement on the BCL to prevent either party from being actively and maliciously authorized. KeyStore is a keystore of a fully encrypted database, which maintains key information of a user, and the behavior control list can be stored in the keystore.

A signing process between the first user and the requesting party is as follows, the contents of a BCL Request (a BCL request for an agreement) may be prepared by the requesting party (Subject) or the first user (Issuer) according to different scenarios.

When the requesting party (Subject) clearly knows the specific contents of a target behavior control list (BCL), the requesting party (Subject) can prepare and initiate a request for an agreement. After receiving the request for the agreement, the first user will review the data processing rule agreed upon in the request for the agreement. If the first user considers that the request for agreement of the requesting party is compliant, the first user will perform a signing on the data processing rule, and the data processing rule will take effect on the requesting party. If the first user does not approve the request for the agreement of the requesting party, the signing will be rejected and the data processing rule will not take effect. Obviously, the requesting party will not be able to perform any operations on the target data according to the data processing rule.

When the first user (the authorizing party, Issuer) actively authorizes the requesting party, the first user prepares a behavior control permission that need to be opened to the requesting party, whether data is desensitized, and a corresponding database or target data. When there are multiple requesting parties, different data processing rules can be set respectively according to different levels and data processing requirements of different requesting parties, so that data processing behaviors of the requesting parties can be restricted to a greatest extent while meeting basic data processing requirements of the requesting parties, thereby ensuring security of visible target data to the requesting parties.

In practical applications, an initiating party can notify an opposite end to participate in the signing through a review platform or a review application. Only when the requesting party and the first user have completed the signing of the data processing rule, that is, the BCL Request is agreed, will the BCL officially take effect, and the requesting party can perform a corresponding data processing on the target data of the first user within a scope permitted by the data processing rule.

In one or more embodiments of the present application, the obtaining the first identifier of the first user to which the target data belongs includes: querying an identity identifier of the first user in a database that stores the target data according to the processing request; and searching for the first identifier of the first user based on the identity identifier.

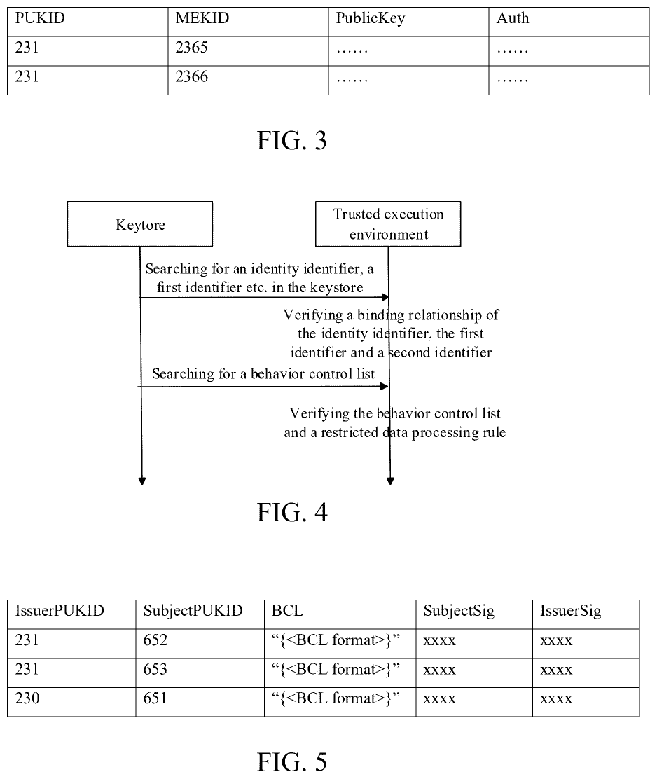

FIG. 3 is a schematic diagram of a key pair table provided by an embodiment of the present application. As can be seen from FIG. 3, a same first user may have different identity identifiers (i.e., MEKID identity in FIG. 3) in different databases. Therefore, for the convenience of management, each user (entity user) in a multi-user system has a globally unique first identifier (a public key in a public-private key pair, that is, PUKID in FIG. 3). After receiving a processing request, a corresponding identity identifier is determined according to information related to target data carried in the processing request, and then a corresponding first identifier is searched out according to a binding relationship. As can be seen from FIG. 3, the public key PUKID and multiple MEKID identities are in a one-to-multi binding relationship. A weak binding manner is performed through MEKID. The weak binding manner allows the user to use a same public key PUKID in different databases. This facilitates efficient management of the databases by the first user.

In one or more embodiments of the present application, the searching for the data processing rule pre-agreed upon by the first user and the requesting party according to the first identifier and the second identifier includes: determining whether the requesting party is a requesting party authorized by the first user based on the first identifier of the first user to which the target data belongs; and if the requesting party is authorized by the first user, searching for a data processing rule preset for the requesting party that is pre-agreed upon by the first user and the requesting party.

FIG. 4 is a schematic diagram of a verifying process of permission of a requesting party provided by an embodiment of the present application. As can be seen from FIG. 4, before performing the data processing behavior such as analysis and computing, it is necessary to verify and ensure that a current requesting party has permission to access and compute the target data through the behavior control list. A verifying process of related permission of data processing rule of the requesting party is carried out in a fully encrypted database to ensure that a result is credible.

During the verifying process, in addition to verify whether the requesting party has obtained authorization of the first user, it is also necessary to verify whether a processing operation specified by the processing request complies with the data processing rule on the basis that the pre-agreed data processing rule preset for the requesting party are searched out. After all verifications are passed, the requesting party is allowed to process the target data. Of course, it is also possible to only verify whether the requesting party has obtained the authorization of the first user, and then determine whether the processing operation complies with the data processing rule when the requesting party actually processes the data.

A same user has different identity identifiers (MEKIDs) in different databases. After receiving the processing request for the target data from the requesting party, the database queries the first identifier of the first user with a binding relationship from a key pair table (Key Pair Table) based on an identity identifier (MEKID) given by the target data involved in computing.

In one or more embodiments of the present application, the determining whether the requesting party is the requesting party authorized by the first user includes: searching for a second identifier of a requesting party bound to the identity identifier of the first user based on the behavior control list stored in the keystore; and if the requesting party that sends the processing request matches the second identifier of the requesting party bound to the identity identifier of the first user, determining that the requesting party is authorized.

In the behavior control list, the first user establishes a binding relationship with the second identifier of the requesting party through the first identifier, and the data processing rule agreed upon between the first user and the requesting party is added or associated in the behavior control list. A processing request sent by the requesting party carries information related to the target data that the requesting party wants to process, as well as information (for example, read-only, write-only, read-write, etc.) related to a manner in which the requesting party wants to process the target data. Therefore, after determining that the requesting party is a requesting party authorized by the first user, the data processing rule preset for the requesting party pre-agreed upon between the first user and the requesting party is searched for. In practical applications, the first user can set different data processing rules for different requesting parties. After searching out the data processing rule, it is necessary to further determine whether the information related to the manner in which the requesting party wants to process the target data matches the data processing rule. If it is matched, the requesting party is permitted to perform a relevant data processing according to the data processing rule. Otherwise, the requesting party is denied to perform the data processing on the target data. During the data processing performed by the requesting party, any violation of the data processing rule will be prohibited or rejected.

In one or more embodiments of the present application, the searching for the data processing rule preset for the requesting party that is pre-agreed upon by the first user and the requesting party includes: querying a data processing rule bound to the second identifier in the behavior control list based on the second identifier of the requesting party; and taking the data processing rule bound to the second identifier as the data processing rule preset by the requesting party.

FIG. 5 is a schematic diagram of a behavior control list provided by an embodiment of the present application. As can be seen from FIG. 5, a user can has multiple databases. A BCL is issued based on a public key identity (PUKID) of the user, which allows unified authorization management for a same user, and avoids the databases to authorize respectively one by one when the same user is in different databases (with different MEKIDs). After receiving the processing request sent by the requesting party, the databases obtain the first identifier of the first user to which target data belongs. Furthermore, by querying the behavior control table (BCL) and whether the requesting party who initiates the processing request has obtained authorization of the first user, if the processing request has obtained the authorization, the data processing rule agreed upon by the first user and the requesting party is further searched for.

For example, as shown in FIG. 5, assuming that a PUKID (a first identifier) of a first user is 231, requesting parties 652 and 653 are bound in a behavior control list. Assuming that at this time, a database receives a processing request from the requesting party 652, and searches out the requesting party 652 and a corresponding data processing rule in a behavior control list bound to the first user 231, then the requesting party 652 is allowed to process target data according to an agreed data processing rule. Assuming that at this time, the database receives a processing request from a requesting party 651 to process the target data of the first user 231, but after querying the behavior control list, no binding relationship is searched out between the first user 231 and the requesting party 651, then it is considered that the first user 231 and the requesting party 651 have not signed an agreed data processing rule, and the requesting party 651 does not have a data processing permission to the first user 231. Assuming again that at this time, the database receives a processing request from the requesting party 653 for processing other data (data other than the target data) of the first user 231, although the requesting party 653 is searched out in the behavior control list, the processing request will be rejected since it exceeds a data processing rule agreed upon by both parties.

In one or more embodiments of the present application, the generating the behavior control list containing the data processing rule includes: generating the data processing rule based on a data processing manner restricted by the first user for the requesting party; and/or, generating the data processing rule based on a computing type restricted by the first user for the requesting party; and/or, generating the data processing rule based on a data desensitization processing manner restricted by the first user for the requesting party; and generating the behavior control list according to an established binding relationship of the data processing rule with the first user and the requesting party.

In practical applications, there are many types of data processing rules agreed upon by the requesting party and the first user. For example, it may be a data processing rule that constrains behavior of the requesting party, including a data processing rule that restricts a data processing manner of the requesting party; and/or a data processing rule generated for a computing type restricted by the requesting party.

The data processing manner mentioned here includes: decrypt (similar to read permission), authorized resources can only be used to decrypt data; encrypt (similar to write permission), authorized resources can only be used to encrypt data, etc. The calculation type mentioned here includes: compare-only, authorized resources can only be used for a comparing operation; computing-only, authorized resources can only be used for a numerical computing operation; aggregate-only, authorized resources can only be used for an aggregating computing operation, etc.

In addition, the data processing rule can also be used to perform a desensitization processing on the target data, because in some cases, plaintext data needs to be displayed directly to the requesting party. However, in a case of meeting processing requirements of the requesting party for the target data, some key information in the target data do not want to be seen by the requesting party, the target data can be desensitized and then returned. The data desensitization manner mentioned here includes but is not limited to data masking (e. g., pseudonym replacement, noise addition, data replacement) and data blurring (e. g., aggregation based on time/data attributes) and other desensitization technologies. Of course, in practical applications, users can also customize a rule according to their needs.

In particular, the data processing rule related to data desensitization is set for the requesting party in the behavior control list. A combination of BCL and the desensitization technology enable that the authorized requesting party can only use the desensitized target data, and security of user data is further improved. That is, it can meet use requirements of the requesting party or improve convenience of operation and maintenance while ensuring that the target data is not completely leaked.

In one or more embodiments of the present application, the searching for the second identifier of the requesting party bound to the identity identifier of the first user based on the behavior control list stored in the keystore includes: searching for the first identifier corresponding to the target data based on the behavior control list stored in the keystore; and searching for the second identifier of the bound requesting party and at least one database authorized to the requesting party according to the first identifier.

In practical applications, a same user can manage multiple databases at the same time, and the first user has different identity identities in different databases. Moreover, authorization for a same requesting party obtained by the first user in different databases may be different. For example, an authorization of target data 1 in a first database managed by the first user to the requesting party is read-only permission. and an authorization of target data 2 in a second database managed by the first user to the requesting party is write-only permission.

In the processing request sent by the requesting party, information related to the target data that the requesting party wants to process is carried, which first identifier the target data corresponds to can be acknowledged, and then multiple identity identifiers with a binding relationship are determined based on the first identifier in the key pair table. When determining an authorization status of the requesting party, at least one identity identifier corresponding to the target data and at least one database respectively authorized to the requesting party by each identity identifier are searched out, thereby achieving efficient management of multiple databases by the user, setting different permission contents for a same requesting party according to different databases, achieving refined permission management and improving data security protection effect.

In one or more embodiments of the present application, after searching for the requesting party authorized by the first user, the method also includes: if a permission revocation instruction for the data processing rule issued by the first user or the requesting party is searched out in the behavior control list, terminating a processing permission to the target data of the requesting party.

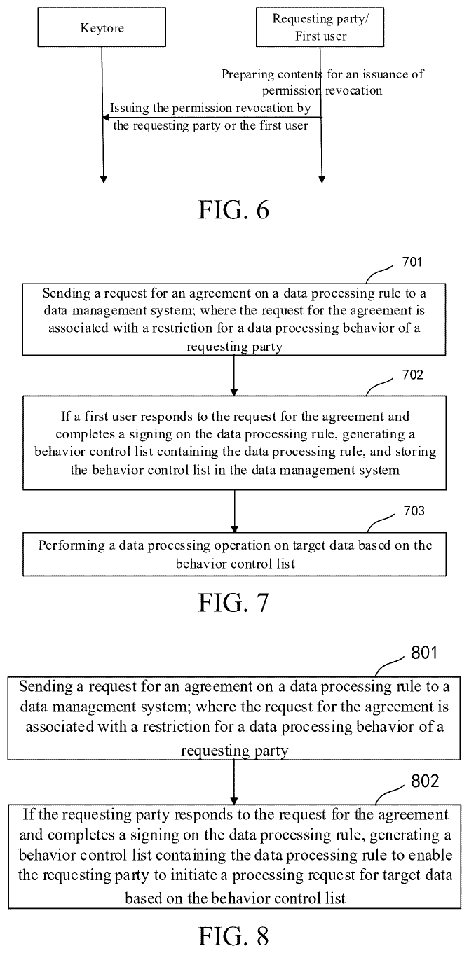

FIG. 6 is a schematic diagram of a revoking process of permission provided by an embodiment of the present application. As can be seen from FIG. 6, a first user (an authorizing party, i.e., a first user (Issuer)) issues permission recall (Behavior Recall List, BRL) to revoke authorization to a requesting party (an authorized party Subject). The BRL only needs to be issued by either participant (the first user Issuer or the requesting party Subject) and does not need a signing. After either party completes an issuance of the permission revocation, the permission to process the target data of the requesting party will be terminated. It should be noted that when issuing the permission revocation, a targeted issuance can be achieved. For example, the first user authorizes the requesting party to process target data 1 in a first database and target data 2 in a second database according to their respective agreed data processing rule. If the permission revocation is issued to the target data 1, it will not affect a normal data processing operation on the target data 2 performed by the requesting party according to the data processing rule. Through the above solution, accurate management of target data security can be achieved, and security of visible data to the requesting party can be protected to a greatest extent while meeting data processing needs of the requesting party.

Based on a same approach, embodiments of the present application also provide another data processing method. FIG. 7 is a flowchart of another data processing method provided by an embodiment of the present application. The method can be applied to a requesting party device terminal. The method specifically includes the following steps:
701, sending a request for an agreement on a data processing rule to a data management system; where the request for the agreement is associated with a restriction for a data processing behavior of a requesting party;
702, if a first user responds to the request for the agreement and completes a signing on the data processing rule, generating a behavior control list containing the data processing rule, and storing the behavior control list in the data management system; and
703, performing a data processing operation on target data based on the behavior control list.

In the embodiment of the present application, the request for the agreement is initiated by the requesting party. In practical applications, the request for the agreement can also be initiated by the first user, and be received by the requesting party (specifically, reference please made to the above embodiments or an embodiment corresponding to FIG. 7). After the requesting party and the first user complete the agreement on the behavior control list together, the behavior control list will take effect, and the requesting party can process data according to an agreed data processing rule. Specific technical solutions can be found in respective embodiments corresponding to FIG. 1 to FIG. 6.

Based on a same approach, embodiments of the present application also provide yet another data processing method. FIG. 8 is a flowchart of yet another data processing method provided by an embodiment of the present application. The method can be applied to a first user device terminal. The method specifically includes the following steps:
801, sending a request for an agreement on a data processing rule to a data management system; where the request for the agreement is associated with a restriction for a data processing behavior of a requesting party; and
802, if the requesting party responds to the request for the agreement and completes a signing on the data processing rule, generating a behavior control list containing the data processing rule to enable the requesting party to initiate a processing request for target data based on the behavior control list.

In the embodiment of the present application, the request for the agreement is initiated by the first user. In practical applications, the request for the agreement can also be initiated by the requesting party, and be received by the first user (specifically, reference please made to the above embodiments or an embodiment corresponding to FIG. 8). After the requesting party and the first user complete the agreement on the behavior control list together, the behavior control list will take effect, and the requesting party can process data according to an agreed data processing rule. Specific technical solutions can be found in respective embodiments corresponding to FIG. 1 to FIG. 6.

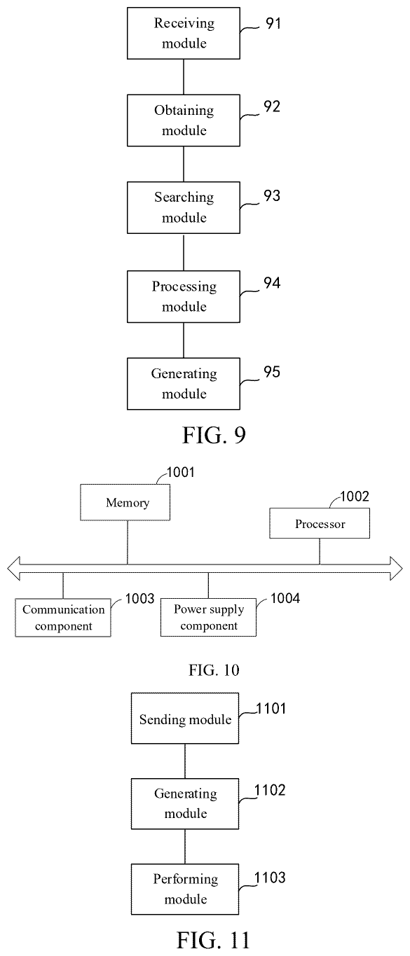

Based on a same approach, embodiments of the present application provide a data processing apparatus. FIG. 9 is a structure schematic diagram of a data processing apparatus provided by an embodiment of the present application. The data processing apparatus includes:
a receiving module 91, configured to receive a processing request for target data sent by a requesting party having an access permission;
a obtaining module 92, configured to obtain a first identifier of a first user to which the target data belongs and a second identifier of the requesting party;
a searching module 93, configured to search for a data processing rule pre-agreed upon by the first user and the requesting party according to the first identifier and the second identifier; and
a processing module 94, when a processing operation specified by the processing request complies with the data processing rule, configured to process the target data according to the data processing rule to feedback corresponding response information to the requesting party.

In an implementation, the obtaining module 92 is configured to query an identity identifier of the first user in a database that stores the target data according to the processing request; and search for the first identifier of the first user based on the identity identifier.

In an implementation, the searching module 93 is configured to determine whether the requesting party is a requesting party authorized by the first user based on the first identifier of the first user to which the target data belongs; and if the requesting party is authorized by the first user, search for a data processing rule preset for the requesting party that is pre-agreed upon by the first user and the requesting party.

In an implementation, the receiving module 91 is configured to receive a request for an agreement on the data processing rule initiated by the requesting party or the first user; and if the requesting party and the first user complete a signing of the agreement on the data processing rule, generate a behavior control list containing the data processing rule, and storing the behavior control list in a keystore.

In an implementation, the searching module 93 is further configured to search for a second identifier of a requesting party bound to the identity identifier of the first user based on the behavior control list stored in the keystore; and if the requesting party that sends the processing request matches the second identifier of the requesting party bound to the identity identifier of the first user, determine that the requesting party is authorized.

In an implementation, the searching module 93 is further configured to query a data processing rule bound to the second identifier in the behavior control list based on the second identifier of the requesting party; and take the data processing rule bound to the second identifier as the data processing rule preset by the requesting party.

In an implementation, the data processing apparatus further includes a generating module 95, configured to generate the data processing rule based on a data processing manner restricted by the first user for the requesting party; and/or, generate the data processing rule based on a computing type restricted by the first user for the requesting party; and/or, generate the data processing rule based on a data desensitization processing manner restricted by the first user for the requesting party; and generate the behavior control list according to an established binding relationship of the data processing rule with the first user and the requesting party.

In an implementation, the searching module 93 is further configured to search for the first identifier corresponding to the target data based on the behavior control list stored in the keystore; and search for the second identifier of the bound requesting party and at least one database authorized to the requesting party according to the first identifier.

In an implementation, the searching module 93 is further configured to terminate a processing permission to the target data of the requesting party if a permission revocation instruction for the data processing rule issued by the first user or the requesting party is searched out in the behavior control list.

In an implementation, the receiving module 91 is further configured to receive an access request from the requesting party; determine whether the requesting party has the access permission based on the second identifier carried in the access request; and if the requesting party has the access permission, receive the processing request for the target data sent by the requesting party.

An embodiment of the present application also provides an electronic device. The electronic device is a master node electronic device in a computing unit. FIG. 10 is a structure schematic diagram of an electronic device provided by an embodiment of the present application. The electronic device includes a memory 1001, a processor 1002 and a communication component 1003;
the memory 1001, configured to store a program;
the processor 1002, coupled to the memory and configured to execute the program stored in the memory to:
receive a processing request for target data sent by a requesting party having an access permission;
obtain a first identifier of a first user to which the target data belongs and a second identifier of the requesting party;
search for a data processing rule pre-agreed upon by the first user and the requesting party according to the first identifier and the second identifier; and
when a processing operation specified by the processing request complies with the data processing rule, process the target data according to the data processing rule to feedback corresponding response information to the requesting party.

The above memory 1001 may be configured to store various other data to support operations on the electronic device. Examples of such data include instructions for any application or method operating on the electronic device. The memory can be implemented by any type of a volatile or a non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic storage, a flash memory, a magnetic disk or an optical disk.

Furthermore, the processor 1002 in the present embodiment may specifically be: a programmable switching processing chip, in which a data replication engine is configured to replicate received data.

When executing the program in the memory, the above processor 1002 can realize other functions in addition to the above functions, please refer to the descriptions of the above embodiments for details. Furthermore, as shown in FIG. 10, the electronic device also includes a power supply component 1004 and other components.

An embodiment of the present application further provides a non-transitory machine-readable storage medium, the non-transitory machine-readable storage medium stores executable codes thereon. When the executable codes are executed by a processor of an electronic device, the processor is caused to implement the method described in the embodiment corresponding to FIG. 1.

Based on a same approach, embodiments of the present application also provide another data processing apparatus. FIG. 11 is a structure schematic diagram of another data processing apparatus provided by an embodiment of the present application. The data processing apparatus includes:
a sending module 1101, configured to send a request for an agreement on a data processing rule to a data management system; where the request for the agreement is associated with a restriction for a data processing behavior of a requesting party;
a generating module 1102, if a first user responds to the request for the agreement and completes a signing on the data processing rule, configured to generate a behavior control list containing the data processing rule, and store the behavior control list in the data management system; and
a performing module 1103, configured to perform a data processing operation on target data based on the behavior control list.

An embodiment of the present application further provides a computer program product, including computer programs/instructions, when the computer programs/instructions are executed by a processor, the processor is caused to implement the method described in the embodiment corresponding to FIG. 7.

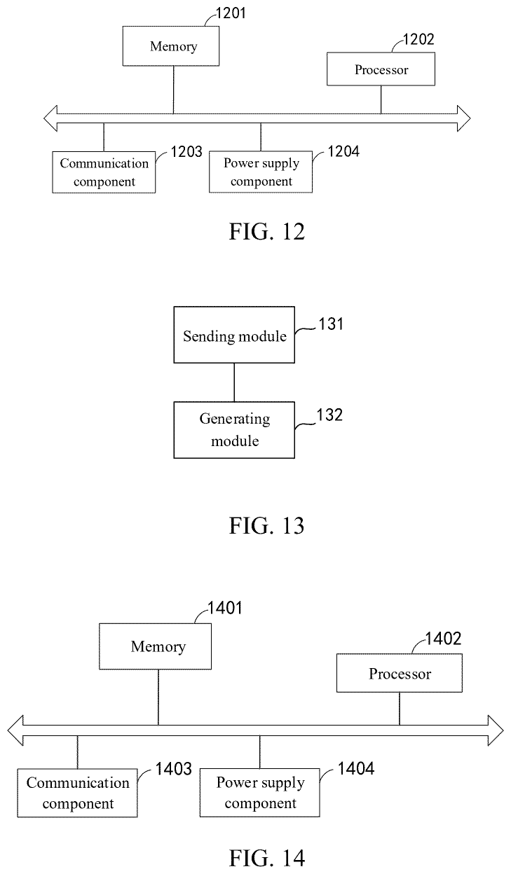

An embodiment of the present application also provides another electronic device. The electronic device is a master node electronic device in a computing unit. FIG. 12 is a structure schematic diagram of another electronic device provided by an embodiment of the present application. The electronic device includes a memory 1201, a processor 1202 and a communication component 1203;
the memory 1201, configured to store a program;
the processor 1202, coupled to the memory and configured to execute the program stored in the memory to send a request for an agreement on a data processing rule to a data management system; where the request for the agreement is associated with a restriction for a data processing behavior of a requesting party; if a first user responds to the request for the agreement and completes a signing on the data processing rule, generate a behavior control list containing the data processing rule, and store the behavior control list in the data management system; and perform a data processing operation on target data based on the behavior control list.

The above memory 1201 may be configured to store various other data to support operations on the electronic device. Examples of such data include instructions for any application or method operating on the electronic device. The memory can be implemented by any type of a volatile or a non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic storage, a flash memory, a magnetic disk or an optical disk.

Furthermore, the processor 1202 in the present embodiment may specifically be: a programmable switching processing chip, in which a data replication engine is configured to replicate received data.

When executing the program in the memory, the above processor 1202 can realize other functions in addition to the above functions, please refer to the descriptions of the above embodiments for details. Furthermore, as shown in FIG. 12, the electronic device also includes a power supply component 1204 and other components.

An embodiment of the present application further provides a non-transitory machine-readable storage medium, the non-transitory machine-readable storage medium stores executable codes thereon. When the executable codes are executed by a processor of an electronic device, the processor is caused to implement the method described in the embodiment corresponding to FIG. 7.

Based on a same approach, embodiments of the present application also provide yet another data processing apparatus. FIG. 13 is a structure schematic diagram of yet another data processing apparatus provided by an embodiment of the present application. The data processing apparatus includes:
a sending module 131, configured to send a request for an agreement on a data processing rule to a data management system; where the request for the agreement is associated with a restriction for a data processing behavior of a requesting party; and
a generating module 132, if the requesting party responds to the request for the agreement and completes a signing on the data processing rule, configured to generate a behavior control list containing the data processing rule to enable the requesting party to initiate a processing request for target data based on the behavior control list.

An embodiment of the present application further provides a computer program product, including computer programs/instructions, when the computer programs/instructions are executed by a processor, the processor is caused to implement the method described in the embodiment corresponding to FIG. 8.

An embodiment of the present application also provides yet another electronic device. The electronic device is a master node electronic device in a computing unit. FIG. 14 is a structure schematic diagram of yet another electronic device provided by an embodiment of the present application. The electronic device includes a memory 1401, a processor 1402 and a communication component 1403;
the memory 1401, configured to store a program;
the processor 1402, coupled to the memory and configured to execute the program stored in the memory to send a request for an agreement on a data processing rule to a data management system; where the request for the agreement is associated with a restriction for a data processing behavior of a requesting party; if the requesting party responds to the request for the agreement and completes a signing on the data processing rule, generate a behavior control list containing the data processing rule to enable the requesting party to initiate a processing request for target data based on the behavior control list.

The above memory 1401 may be configured to store various other data to support operations on the electronic device. Examples of such data include instructions for any application or method operating on the electronic device. The memory can be implemented by any type of a volatile or a non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic storage, a flash memory, a magnetic disk or an optical disk.

Furthermore, the processor 1402 in the present embodiment may specifically be: a programmable switching processing chip, in which a data replication engine is configured to replicate received data.

When executing the program in the memory, the above processor 1402 can realize other functions in addition to the above functions, please refer to the descriptions of the above embodiments for details. Furthermore, as shown in FIG. 14, the electronic device also includes a power supply component 1404 and other components.

An embodiment of the present application further provides a non-transitory machine-readable storage medium, the non-transitory machine-readable storage medium stores executable codes thereon. When the executable codes are executed by a processor of an electronic device, the processor is caused to implement the method described in the embodiment corresponding to FIG. 8.

An embodiment of the present application further provides a data processing system, including:
a data management system, configured to receive a processing request for target data sent by a requesting party having an access permission; obtain a first identifier of a first user to which the target data belongs and a second identifier of the requesting party; search for a data processing rule pre-agreed upon by the first user and the requesting party according to the first identifier and the second identifier; and in a case that a processing operation specified by the processing request complies with the data processing rule, process the target data according to the data processing rule to feedback corresponding response information to the requesting party;
the requesting party, configured to send a request for an agreement on the data processing rule to the data management system; where the request for the agreement is associated with a restriction for a data processing behavior of the requesting party; in a case that the first user responds to the request for the agreement and completes a signing on the data processing rule, generate a behavior control list containing the data processing rule, and store the behavior control list in the data management system; and perform a data processing operation on the target data based on the behavior control list; and
the first user, configured to send a request for an agreement on the data processing rule to the data management system; where the request for the agreement is associated with the restriction for the data processing behavior of the requesting party; and in a case that the requesting party responds to the request for the agreement and completes a signing on the data processing rule, generate the behavior control list containing the data processing rule to enable the requesting party to initiate the processing request for the target data based on the behavior control list.

Based on the above embodiments, data in a database is regarded as private data of a first user, in some cases, the private target data of the first user needs to be processed. In order to better ensure data security in a process of processing target data in an all-round way, the first user can authorize a requesting party to allow it to targeted process corresponding target data in a trusted execution environment. Specifically, when the requesting party is accessing, the requesting party will strictly perform a relevant data processing operation in accordance with data processing behavior authorized for the requesting party in a behavior control list jointly issued by the requesting party and the first user. It can accurately constrain the data processing behavior of the requesting party, meet processing requirements of a third party for the target data, and effectively improve security protection effect during a process that the target data is secure processing.

The apparatus embodiments described above are merely illustrative, units described as separate components may or may not be physically separated, and components displayed as units may or may not be physical units, that is, they may be located in one place or distributed over multiple network units. Some or all of modules may be selected according to actual needs to achieve the objectives of solutions in the embodiments. A person skilled in the art can understand and implement the present application without any creative effort.

Through the description of the above implementations, those skilled in the art can clearly understand that each implementation can be implemented by means of software plus a necessary general hardware platform, and of course can also be implemented by hardware. Based on this understanding, the above technical solutions which essentially or rather contribute to the prior art may be embodied in the form of a software product, which may be stored in a computer-readable storage medium such as a ROM/RAM, a disk, a CD-ROM, etc., and includes a number of instructions to enable a computer device (which may be a personal computer, a server, or a network device, etc.) to execute the various embodiments or certain portions of embodiments.

Finally, it should be noted that the above embodiments are only used to illustrate the technical solutions of the present application, rather than to limit it. Although the present application has been described in detail with reference to the aforementioned embodiments, those skilled in the art should understand that they can still modify the technical solutions described in the aforementioned embodiments, or replace some of the technical features therein with equivalents. However, these modifications or replacements do not deviate the essence of the corresponding technical solutions from the spirit and scope of the technical solutions of the embodiments of the present application.

1. A data processing method, comprising:
receiving a processing request for target data sent by a requesting party having an access permission;
obtaining a first identifier of a first user to which the target data belongs and a second identifier of the requesting party;
searching for a data processing rule pre-agreed upon by the first user and the requesting party according to the first identifier and the second identifier; and
in a case that a processing operation specified by the processing request complies with the data processing rule, processing the target data according to the data processing rule to feedback corresponding response information to the requesting party.

2. The method according to claim 1, wherein the obtaining the first identifier of the first user to which the target data belongs comprises:
querying an identity identifier of the first user in a database that stores the target data according to the processing request; and
searching for the first identifier of the first user based on the identity identifier.

3. The method according to claim 2, wherein the searching for the data processing rule pre-agreed upon by the first user and the requesting party according to the first identifier and the second identifier comprises:
determining whether the requesting party is a requesting party authorized by the first user based on the first identifier of the first user to which the target data belongs; and
in a case that the requesting party is authorized by the first user, searching for a data processing rule preset for the requesting party that is pre-agreed upon by the first user and the requesting party.

4. The method according to claim 3, before the receiving the processing request for the target data sent by the requesting party having the access permission, further comprises:
receiving a request for an agreement on the data processing rule initiated by the requesting party or the first user; and
in a case that the requesting party and the first user complete a signing of the agreement on the data processing rule, generating a behavior control list containing the data processing rule, and storing the behavior control list in a keystore.

5. The method according to claim 4, wherein the determining whether the requesting party is the requesting party authorized by the first user comprises:
searching for a second identifier of a requesting party bound to the identity identifier of the first user based on the behavior control list stored in the keystore; and
in a case that the requesting party that sends the processing request matches the second identifier of the requesting party bound to the identity identifier of the first user, determining that the requesting party is authorized.

6. The method according to claim 5, wherein the searching for the data processing rule preset for the requesting party that is pre-agreed upon by the first user and the requesting party comprises:
querying a data processing rule bound to the second identifier in the behavior control list based on the second identifier of the requesting party; and
taking the data processing rule bound to the second identifier as the data processing rule preset by the requesting party.

7. The method according to claim 5, wherein the generating the behavior control list containing the data processing rule comprises:
performing at least one of the following operations: generating the data processing rule based on a data processing manner restricted by the first user for the requesting party;
generating the data processing rule based on a computing type restricted by the first user for the requesting party; and
generating the data processing rule based on a data desensitization processing manner restricted by the first user for the requesting party; and
generating the behavior control list according to an established binding relationship of the data processing rule with the first user and the requesting party.

8. The method according to claim 5, wherein the searching for the second identifier of the requesting party bound to the identity identifier of the first user based on the behavior control list stored in the keystore comprises:
searching for the first identifier corresponding to the target data based on the behavior control list stored in the keystore; and
searching for the second identifier of the bound requesting party and at least one database authorized to the requesting party according to the first identifier.

9. The method according to claim 1, wherein the receiving the processing request for the target data sent by the requesting party having the access permission comprises:
receiving an access request from the requesting party;
determining whether the requesting party has the access permission based on the second identifier carried in the access request; and
in a case that the requesting party has the access permission, receiving the processing request for the target data sent by the requesting party.

10. A data processing method, comprising:
sending a request for an agreement on a data processing rule to a data management system;
wherein the request for the agreement is associated with a restriction for a data processing behavior of a requesting party;
in a case that a first user responds to the request for the agreement and completes a signing on the data processing rule, generating a behavior control list containing the data processing rule, and storing the behavior control list in the data management system; and
performing a data processing operation on target data based on the behavior control list.

11. A data processing method, comprising:
sending a request for an agreement on a data processing rule to a data management system;
wherein the request for the agreement is associated with a restriction for a data processing behavior of a requesting party; and
in a case that the requesting party responds to the request for the agreement and completes a signing on the data processing rule, generating a behavior control list containing the data processing rule to enable the requesting party to initiate a processing request for target data based on the behavior control list.

12. (canceled)

13. An electronic device, comprising:
a memory and a processor;
wherein the memory, configured to store a program;
the processor, coupled to the memory and configured to execute the program stored in the memory to implement the method according to claim 1.

14. (canceled)

15. The electronic device according to claim 13, wherein the processor is configured to:
query an identity identifier of the first user in a database that stores the target data according to the processing request; and
search for the first identifier of the first user based on the identity identifier.

16. The electronic device according to claim 15, wherein the processor is configured to:
determine whether the requesting party is a requesting party authorized by the first user based on the first identifier of the first user to which the target data belongs; and
in a case that the requesting party is authorized by the first user, search for a data processing rule preset for the requesting party that is pre-agreed upon by the first user and the requesting party.

17. The electronic device according to claim 16, wherein the processor is configured to:
receive a request for an agreement on the data processing rule initiated by the requesting party or the first user; and
in a case that the requesting party and the first user complete a signing of the agreement on the data processing rule, generate a behavior control list containing the data processing rule, and storing the behavior control list in a keystore.

18. The electronic device according to claim 17, wherein the processor is configured to:
search for a second identifier of a requesting party bound to the identity identifier of the first user based on the behavior control list stored in the keystore; and
in a case that the requesting party that sends the processing request matches the second identifier of the requesting party bound to the identity identifier of the first user, determine that the requesting party is authorized.

19. The electronic device according to claim 18, wherein the processor is configured to:
query a data processing rule bound to the second identifier in the behavior control list based on the second identifier of the requesting party; and
take the data processing rule bound to the second identifier as the data processing rule preset by the requesting party.

20. The electronic device according to claim 18, wherein the processor is configured to:
perform at least one of the following operations: generating the data processing rule based on a data processing manner restricted by the first user for the requesting party; generating the data processing rule based on a computing type restricted by the first user for the requesting party; and generating the data processing rule based on a data desensitization processing manner restricted by the first user for the requesting party; and
generate the behavior control list according to an established binding relationship of the data processing rule with the first user and the requesting party.

21. The electronic device according to claim 18, wherein the processor is configured to:
search for the first identifier corresponding to the target data based on the behavior control list stored in the keystore; and
search for the second identifier of the bound requesting party and at least one database authorized to the requesting party according to the first identifier.

22. The electronic device according to claim 13, wherein the processor is configured to:
receive an access request from the requesting party;
determine whether the requesting party has the access permission based on the second identifier carried in the access request; and
in a case that the requesting party has the access permission, receive the processing request for the target data sent by the requesting party.
